(19) United States
(12) Patent Application Publication
(10) Pub. No.: US 2023/0090186 A1
(43) Pub. Date: Mar. 23, 2023

(54) CLOG FREE BAITWELL FILTER SYSTEM

(71) Applicant: Campbell WATTS, JR., Cedar Rapids, IA (US)

(72) Inventor: Campbell WATTS, JR., Cedar Rapids, IA (US)

(21) Appl. No.: 17/949,969

(22) Filed: Sep. 21, 2022

Related U.S. Application Data
(60) Provisional application No. 63/247,081, filed on Sep. 22, 2021.

(51) Int. Cl. A01K 97/05; A01K 63/04

(52) U.S. Cl. CPC A01K 97/05; A01K 63/045

(57) ABSTRACT

A clog free baitwell filter system for baitwell systems that use a drain tube has a filter tube configured to fit over a baitwell drain tube. The filter tube has a plurality of filter tube holes around the periphery wherein water passes through the plurality of filter tube holes. A filter fitting is configured to fit over a standard baitwell plumbing drain fixture; and a clog free filter cap removably disposed over a top portion of said filter tube.

### CROSS REFERENCE TO RELATED APPLICATIONS

This application claims priority and herein incorporates by reference U.S. provisional patent application 63/247,081, filed Sep. 22, 2021.

Historically, fishing has been an important source of protein for the human population. Today, sport fishing is also very important and a popular hobby generating millions to the economy. When catching game fish and large fish, many use live bait such as shiners, fathead minnows or other bait fish. It is important to keep the bait fish alive and active to maximize the attractiveness of the bait.

The use of a baitwell or live-well greatly improves the life of bait fish because the water is always circulating and is well oxygenated. A drain pipe is used to keep the water at a desired level by allowing the water to drain when rising past the edge of the drain pipe. Unfortunately, debris and even the bait fish can get caught in the drain pipe. To help alleviate this, strainer caps are placed over the top of the drain pipe. This helps but does not solve the problem and debris often clogs the drain pipe causing the baitwell to malfunction. In extreme cases, a clogged baitwell can lead to the boat flooding or actually sinking.

There is a need for an easy to install baitwell filter that overcomes the problem of debris and fish clogging the drain pipe. Additionally, there is a need for a baitwell filter that can be installed in already produced baitwells without the need to buy a new baitwell.

### SUMMARY OF THE INVENTION

A clog free baitwell filter system for baitwell systems that have a drain tube provides a filter tube configured to fit over a baitwell drain tube. The filter tube has a plurality of filter tube holes around the periphery wherein water passes through the plurality of filter tube holes. A filter fitting is disposed in a baitwell plumbing drain fixture and the filter tube is held in place by fitting over an outer portion of a collar portion of the filter fitting with the filter baitwell drain tube enclosed therein; and a clog free filter cap removably disposed over a top portion of the filter tube.

Other features and advantages of the instant invention will become apparent from the following description of the invention which refers to the accompanying drawings.

### BRIEF DESCRIPTION OF THE DRAWINGS

FIG. 1 is an illustration of a clog free baitwell filter system according to an embodiment of the invention.

FIG. 2 is an illustration of the clog free baitwell filter system shown in FIG. 1 in an assembled configuration.

FIG. 3 is an illustration of the clog free baitwell filter system in a typical baitwell.

FIG. 4 is an illustration of the clog free filter fitting shown in FIG. 1.

FIG. 5 is an illustration of the clog free filter cap shown in FIG. 1.

FIG. 6 is an illustration of a prior art baitwell system.

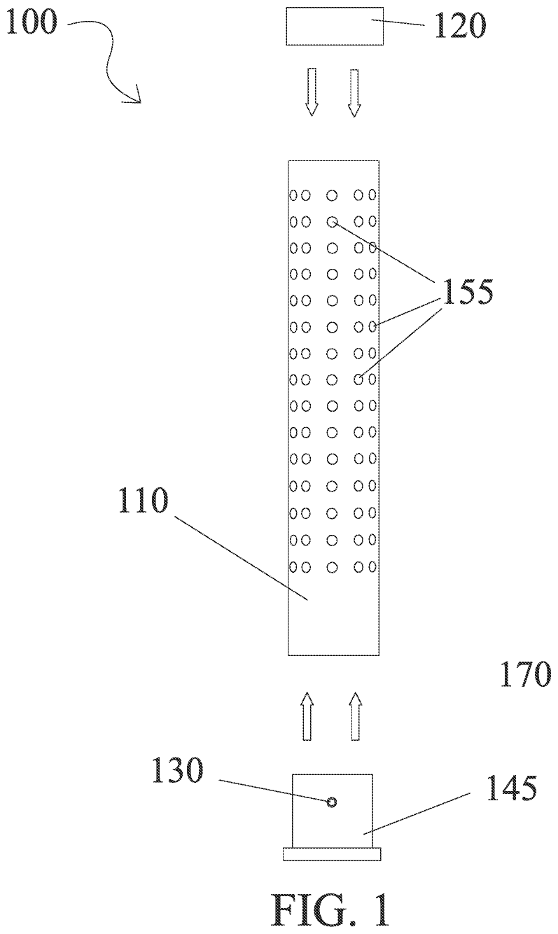

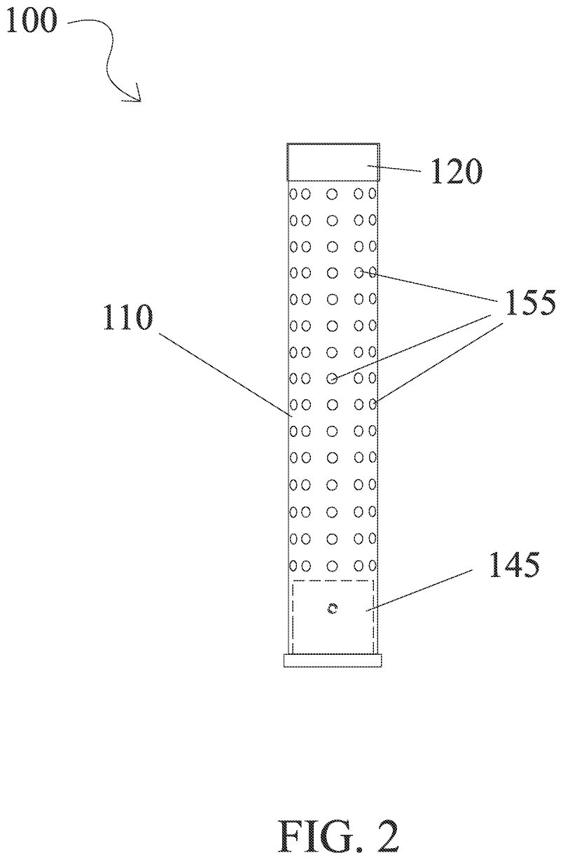

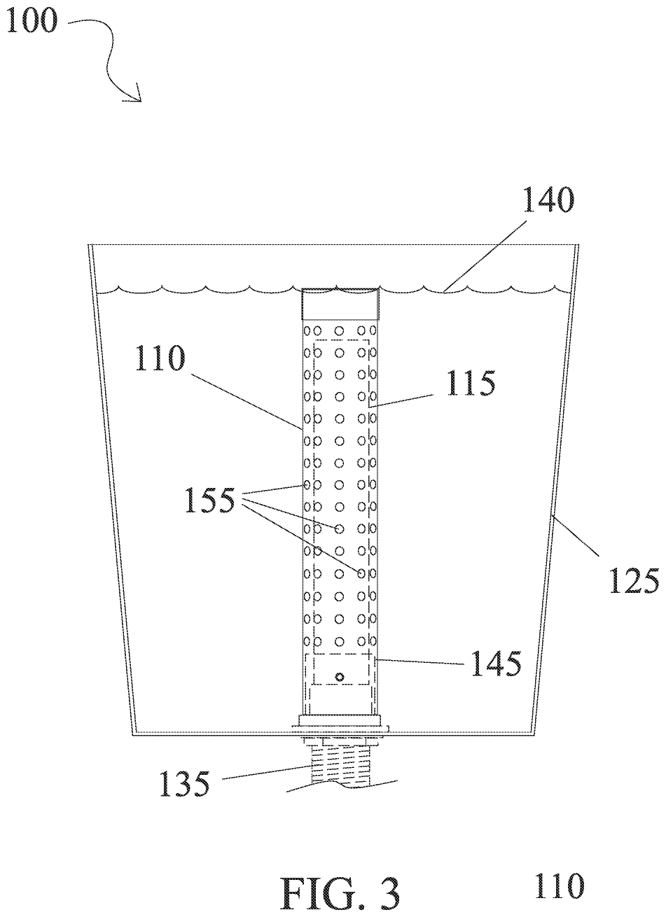

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

As shown in the figures, a clog free baitwell filter system 100 includes a clog free filter tube 110, a clog free filter cap 120 and a clog free filter fitting 165 assembled in a baitwell tank 125. Most prior art systems utilize a drain tube cap 170. If using a prior art tube 115, and this drain tube cap 170 is removed before using clog free baitwell filter system 100. Clog free filter fitting 145 is placed over drain tube 115 and baitwell plumbing fitting 135 and may be secured using fasteners 130. Fasteners 130 are set screws; however, it is possible to eliminate the use of any fasteners and simply have clog free filter fitting 145 friction fit over baitwell plumbing fixture 135.

After securing clog free filter fitting 145 to baitwell plumbing fitting 135, clog free filter tube 110 is placed over clog free filter fitting 145 and then clog free filter cap 120 is placed over the top of clog free filter tube 110. Clog free filter tube 110 has a plurality of clog free filter tube holes 155 circumferentially disposed around clog free filter tube 110 to allow water 140 to drain through in an area between drain tube 115 and clog free filter tube 110. Water also passes through clog free filter cap 120 through a plurality of clog free filter cap holes 160 as water 140 rises above the level of the top of clog free filter tube 110 to maintain a specified water level. In a typical embodiment, 15¼″ holes running down the length of the tube in 10 rows giving a total of 150 holes all around the perimeter. A typical length for use in many baitwell, is 12 inches with a diameter of 2.5 inches and a wall thickness of ⅛^{th} inch. Of course other numbers of holes may be used but should be enough to provide a good water flow. Clog free filter cap 120 may be made of red plastic to enhance visibility, but could also be made of any suitable color or material. Clog free filter cap holes 160 are typically used only if the water level exceeds the typical flow rate and allows even more water to drain therein. Typically, all holes (155 and 160) are ¼ inch in diameter to balance filtering with sufficient water flow, but again, other diameter size holes may be used as long as enough water is able to pass through while filtering out clogging material such as dead bait, seaweed, etc. In tests, half of the holes are blocked and the remainder of holes still provides sufficient water flow to prevent overfilling and potentially flooding or even sinking a boat fitted with a baitwell. Additionally, because of the improved flow rate, more powerful supply pumps may be used which may increase the oxygen level in the water which may improve the health of the bait.

In practice, clog free baitwell filter system 100 allows water to be circulated from different levels of baitwell tank 125 instead of just draining water off the top of water in baitwell tank 125.

Clog free filter fitting 145 may be produced using a CNC (Computer Numerical Control) machining process to customize and ensure a slip fit over baitwell plumbing fitting 135. Of course other methods may be used to produce clog free fitting 145 as is known in the art as long as clog free filter fitting 145 is secured to drain tube 115.

Clog free filter tube holes 155 are generally large enough to allow water 140 to flow freely yet small enough to capture and prevent debris from clogging drain tube 115. Holes in the range of ¼ inch work well for this purpose, but other dimensioned hole diameters can be used as long as they function to allow enough water to pass through without allowing clogging debris to enter. Additionally, the number of clog free filter tube holes 155 should be sufficient to allow water 140 to freely pass through even if some debris clogs some of the holes. The number of clog free filter tube holes 155 in the embodiment shown is 150; however the exact number of holes used is not critical as long as sufficient to function properly.

The circumference of clog free filter tube 110 is selected by an outside diameter of clog free filter fitting 145 and is important in helping to maintain good water flow without taking up too much functional space in baitwell tank 125. Again, the actual dimension is not critical but should allow proper water flow. Clog free filter tube is made of clear polycarbonate plastic allowing users to visually inspect water flowing therein. Of course, although clear plastic has advantages, it is not essential and other materials may be used such as, but not limited to, translucent or opaque plastic, metal or composite materials.

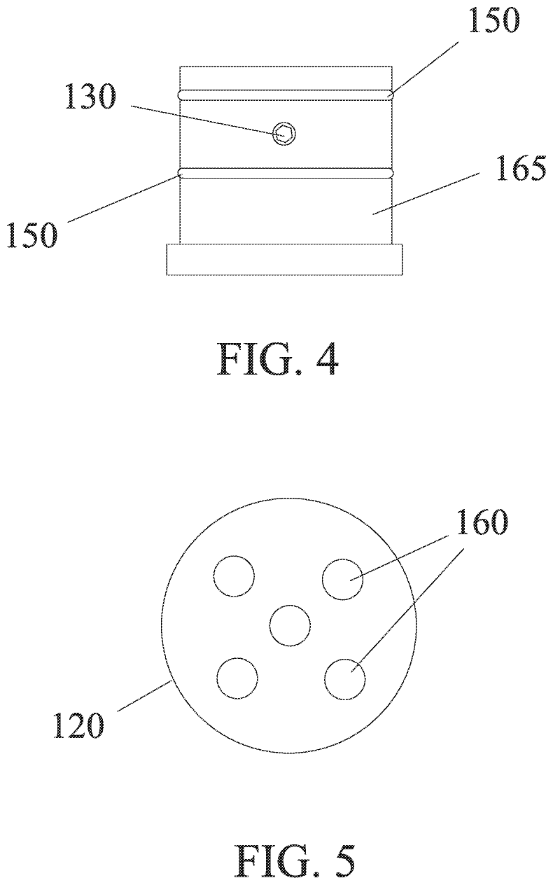

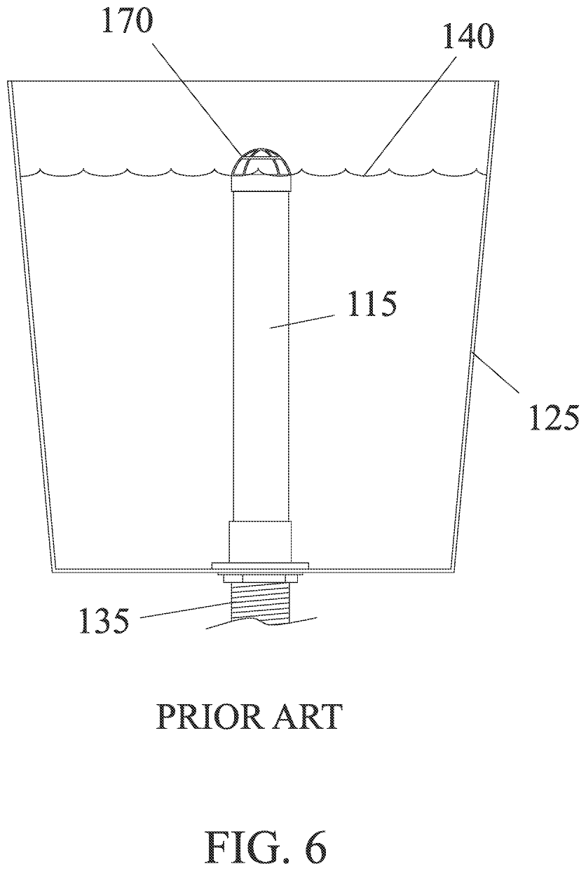

Now referring to FIG. 4, an alternative embodiment of a clog free filter fitting 165 is shown having at least one O-ring 150 to further secure clog free filter fitting 165 to clog free filter tube 110. This embodiment may be used where a water-tight seal is desired between clog free filter tube 115 and clog free filter fitting 165 is desired.

Although the instant invention has been described in relation to particular embodiments thereof, many other variations and modifications and other uses will become apparent to those skilled in the art.

What is claimed is:

1. A clog free baitwell filter system for baitwell systems that use a drain tube comprising:
a filter tube configured to fit over a baitwell drain tube;
said filter tube having a plurality of filter tube holes around the periphery wherein water passes through said plurality of filter tube holes;
a filter fitting disposed in a baitwell plumbing drain fixture wherein said filter tube is held in place by fitting over an outer portion of a collar portion of said filter fitting with said filter baitwell drain tube enclosed therein; and
a clog free filter cap removably disposed over a top portion of said filter tube.

2. The baitwell filter system according to claim 1 further comprising a fastener disposed in said collar portion of said filter fitting where said filter fitting is removably secured to said baitwell plumbing drain fixture.

3. The baitwell filter system according to claim 1 further comprising at least one O-Ring channel disposed on an outer surface of a collar portion of said filter fitting and a O-Ring disposed in said channel wherein a water tight seal is achieved when placing said filter fitting over said baitwell plumbing drain fixture.

4. The baitwell filter system according to claim 1 wherein said clog free filter cap has at least five holes disposed in a top surface therein.

5. The baitwell filter system according to claim 1 wherein said filter tube is longer than said baitwell drain tube wherein water flows into a space between said baitwell drain tube and said clog free filter cap to keep the level of water at a constant level.

6. The baitwell filter system according to claim 1 wherein said filter tube is made of transparent polycarbonate plastic whereby said filter tube is visually inspectable.

7. The baitwell filter system according to claim 1 wherein said plurality of filter tube holes are ¼ inch in diameter.

8. The baitwell filter system according to claim 7 wherein said plurality of filter tube holes comprise at least 150 holes.

9. The baitwell filter system according to claim 1 wherein said filter fitting is removably secured by friction fitting over said baitwell plumbing drain fitting.

10. A method of converting a baitwell tank to a clog free baitwell filter system comprising the steps of:
obtaining a baitwell filter system comprising;
a filter tube configured to fit over a baitwell drain tube;
said filter tube having a plurality of filter tube holes
around the periphery wherein water passes through said plurality of filter tube holes;
a filter fitting disposed in a baitwell plumbing drain
fixture wherein said filter tube is held in place by fitting over an outer portion of a collar portion of said filter fitting with said filter baitwell drain tube enclosed therein; and
a clog free filter cap removably disposed over a top portion of said filter tube,
removing a drain tube cap from a drain tube in said tank;
removing said drain tube from said baitwell plumbing drain fitting;
placing said filter fitting in said baitwell plumbing drain fitting;
placing said drain tube in said filter fitting wherein said drain tube is connected to said baitwell plumbing fitting through said filter fitting;
placing said filter tube over said drain tube and removably securing said filter tube along an outside edge of said collar portion of said filter fitting; and
placing said clog free filter cap on a top portion of said filter tube.

11. The method according to claim 10 further comprising the step of securing said filter fitting to said to said drain tube using a fastener disposed within a collar portion of said filter fitting.

12. The method according to claim 10 wherein said filter tube is made of transparent polycarbonate plastic whereby said filter tube is visually inspectable.
